(19) United States
(12) Patent Application Publication
(10) Pub. No.: US 2010/0172274 A1
(43) Pub. Date: Jul. 8, 2010

(54) Energy saving using cellular footprint for mobile device Wi-Fi access point discovery

(75) Inventors: Haitao Wu, Beijing (CN); Kun Tan, Beijing (CN); Yongguang Zhang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/349,520

(22) Filed: Jan. 7, 2009

(51) Int. Cl. G08C 17/00

(52) U.S. Cl. 370/311

(57) ABSTRACT

Described is a technology in which a Wi-Fi enabled mobile computing device conserves power by only selectively scanning to discover a potential access point for connecting. In one aspect, a cellular footprint, comprising the cellular tower identifier(s) and corresponding signal strength information, determines whether to perform or delay the Wi-Fi scan. The footprint may be used to detect mobile user location changes and compare with history, so as to delay scanning when the device has not sufficiently moved, or delay scanning when the history indicates little chance of a successful discovery/connection at the current location.

### BACKGROUND

Wireless networking (generally referred to by WLAN and/or Wi-Fi) is a relatively high-bandwidth way to communicate data, including higher bandwidth connectivity for mobile telephone users. However, Wi-Fi consumes a significant amount of energy on power-constrained mobile devices, and thus needs to be turned off much of the time to preserve battery life.

In particular, a device (its network identification card, or NIC) can enter a sleep/power saving mode once it becomes associated with a wireless access point that supports power saving modes. However, when trying to locate a wireless access point, the NIC has to scan to switch channels, which consumes a lot of energy. For example, in the IEEE 802.11b standard there are eleven channels, and a typical scan takes 150 milliseconds per channel, whereby scanning all eleven channels takes 1.65 seconds. Nevertheless, until an access point is found, the device has to continuously operate in scan mode, otherwise an access point may be missed, because an access point's beacon messages may arrive at any time.

In sum, to discover potential neighboring Wi-Fi access point, a mobile telephone device has to operate in scan mode, however scan is very costly in terms of energy consumption. A manually triggered scan is one possible solution, but in general is very undesirable to device users.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a mobile device conserves energy by delaying scanning for a Wi-Fi access point when there is little likelihood of finding one and/or connecting to one. In one aspect, unless a mobile device (that is not currently connected to a Wi-Fi access point) has moved beyond a threshold distance from its previous location, Wi-Fi scanning for an access point is delayed, since it is not likely that one will be found as the device has not sufficiently moved. If moved, additional information is considered in determining whether to perform a Wi-Fi scan for an access point. For example, if the device is moving too quickly, then a scan may be delayed. As another consideration, if based on historical information the current location is known to be one in which no access point will be found or will connect, then a scan may be delayed.

In another aspect, the mobile device location is based upon cellular tower information received at the mobile device. For example, a footprint indicative of a location may be determined based upon cellular tower identifiers, and/or signal strength information. Based upon signal strength changes or changes to the set of identifiers (towers) which are in range, a footprint corresponding to movement and/or location may be obtained and processed.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components in a mobile device for selectively scanning for a Wi-Fi access point based upon movement and/or footprint data.

FIG. 2 is a representation of how a mobile device may move relative to an access point.

FIG. 3 is a flow diagram showing example steps taken to determine whether to perform a scan for a Wi-Fi access point based upon movement and/or footprint data

FIG. 4 shows an illustrative example of a mobile computing device/environment into which various aspects of the present invention may be incorporated.

### DETAILED DESCRIPTION

Various aspects of the technology described herein are generally directed towards an adaptive scan scheme, in which the time to scan (scan frequency) is adjusted by the mobile telephone user's history and/or existing location. For example, a mobile telephone device can use information about nearby cellular towers, such as each cellular tower's identifier (ID) and/or signal strength, to determine whether the user has changed his or her location and thus may have moved into or out of a potential access point's coverage range. In one example implementation, a current set of (one or more) cellular tower identifiers and their respective signal strengths are referred as a footprint, because it changes when a mobile telephone moves out a certain range. The granularity of such a footprint is at a level of several meters, which is sufficient for purposes of Wi-Fi access point discovery as described herein. Note that as used herein, the term “location” and “footprint” are generally synonymous, as a footprint determines a location (which is not an absolute location, but one that is relative to other footprints).

While cellular towers and signal strengths are used for establishing a footprint in one example implementation, it is understood that this is only a non-limiting example, and that other location information and data may be used. For example, GPS devices, a user's pattern (e.g., work commutes during weekdays) and so forth may be used for adaptive scanning instead of or in addition to cellular-based footprints. Further, as used herein, “Wi-Fi” refers to any wireless connection technology, including WLAN, WiMax, and so forth. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and power saving in general.

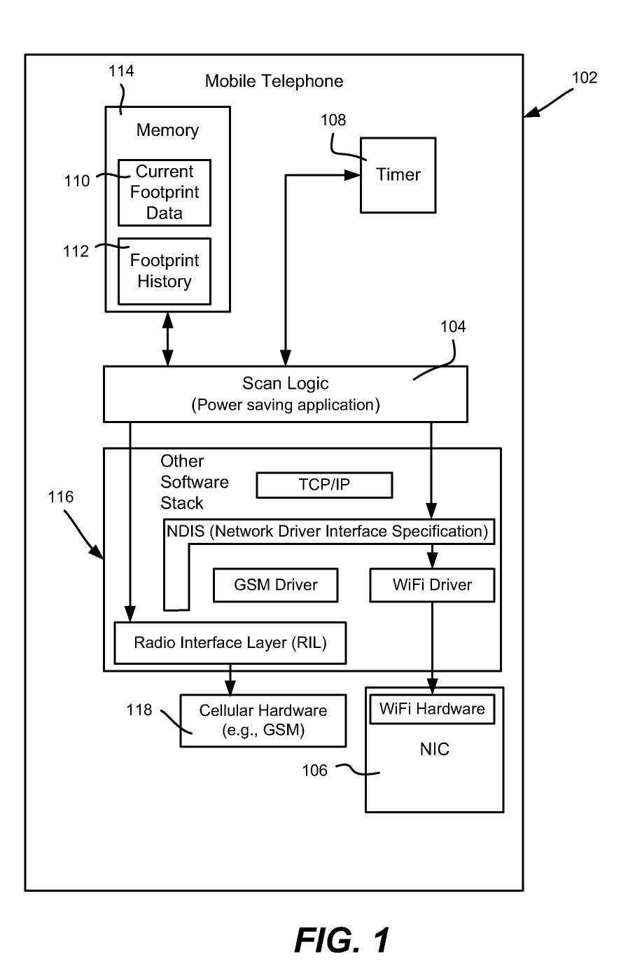

FIG. 1 shows various aspects related to footprint-based Wi-Fi scanning, which significantly reduces the number of unnecessary Wi-Fi scans and thereby conserves energy on a mobile telephone 102 (or other device). In general the mobile telephone 102 includes scan logic 104 (e.g., a power saving application) that controls when the NIC 106 scans for an access point. As described herein, this is based upon a timer 108 (operated by the scan logic), and current footprint data 110 versus a footprint history 112 maintained in memory 114. Also shown in FIG. 1 is an example software stack 116 below the scan logic 104, and cellular hardware 118.

A general idea implemented in the logic 104 considers that the purpose of a scan is to find a potential access point for connection thereto; if the mobile telephone 102 user does not move, then the probability of finding a new access point via a scan is very small. As a result, the scan may be delayed. However, as a device is moved, the moving distance and the access point's coverage distance are considered together.

To this end, the logic 104 provides a scanning scheme based on various locations of the mobile telephone 102 (as the user moves or remains in one place), including cellular tower identifiers and their signal strengths, for example, which provide indications of location and movement without consuming significant energy. In general, when the user does not move, and previous scans at the current user's location obtained no access point or no new access point that can be connected, then the logic 104 performs the scanning very lazily because the probability of finding a new AP is very low. Also, when a user moves very quickly, such as when driving, a scan is not necessary because even scanning can find a new AP, the time left for a valid connection is relatively short when considering that Wi-Fi coverage range is on the order of tens of meters. Thus, only when a user moves very slowly or does not move at all, and there are no scan results for the user's current location (footprint) found in the history 112, is a scan performed.

To detect the movement of a user/determine changes of location with a low cost, the cellular tower information in mobile telephone 102s is used to determine the current footprint data 110. Note that the cellular technology mentioned herein may be based upon GSM, or CDMA, or 3G, as determined by the cellular capability of the phone device. For example, the GSM module on mobile telephone 102 can obtain the nearby GSM tower ID and its corresponding signal strength, which is free (no additional device or energy consuming) because the GSM module is normally always on for mobile telephone 102.

By way of background, in scan mode, the Wi-Fi NIC 106 scans all channels to collect neighboring access point information. The number of channels depends on the type of NIC, e.g., 802.11b has eleven channels, 802.11a has thirteen orthogonal channels, and so on. The time to scan a channel depends on the scanning method, which may be a passive scan or an active scan. In general, any scan mode in a Wi-Fi NIC is a time consuming, and is also energy consuming as the NIC 106 remains awake during the scanning time.

For existing widely-deployed Wi-Fi access points, the coverage range is on the order of dozens of meters. Wi-Fi uses a two-way connection (an ACK frame from receiver to data frame transmitter), whereby the communication range for a mobile telephone 102 is further constrained by the battery-powered telephone, which is less powerful than a wired powered access point. As a result, to obtain reasonable Wi-Fi performance, the distance from the access point to the mobile telephone 102 usually needs to be less than thirty meters to have a strong enough signal that is reasonable for communication.

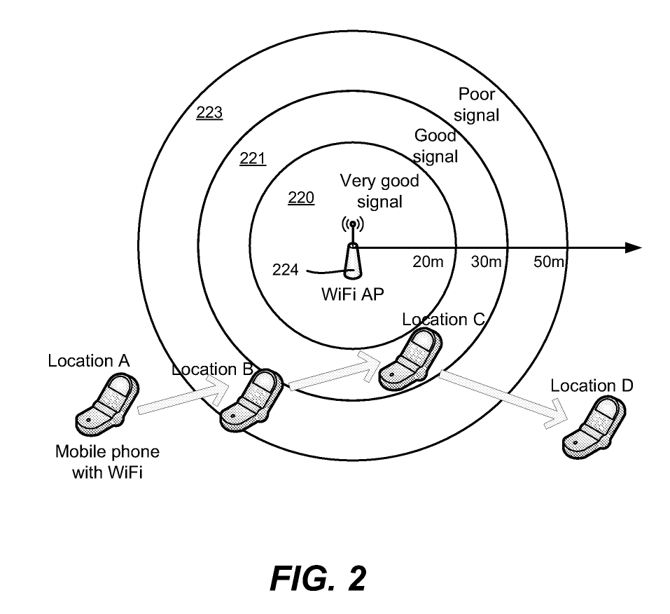

FIG. 2 illustrates the coverage of a Wi-Fi access point as a circle, in which the innermost circle area 220 corresponds to the best reception, the middle circle area 221 the next best, and the outermost circle area 223 the worst. Note that the distances to the access point 224, exemplified as 20 m, 30 m, and 50 m, are only a coarse approximation of granularity for explanation purposes, and not exact values.

FIG. 2 is used to demonstrate a mobile telephone 102 user moving in and out of the coverage of the Wi-Fi access point 224. In this example, the user stays the longest time (e.g., for several hours) at location C, such as at a home or office location. Location A and D represent places with no Wi-Fi access or no authorized Wi-Fi access, such as roads while driving, shopping locations and so forth. Location B represents where the mobile telephone 102 is located a relatively short time (e.g., in minutes), that is, a transition period, such as an elevator, garage, and so forth.

For mobile telephone 102, the cellular radio part can be assumed as always on. Thus, the nearby cellular tower information is free for a mobile device. In this document, we assume that the mobile telephone 102 device can obtain the cellular tower ID and signal strength, which is a typical configuration in existing mobile telephone 102 devices. More information from cellular tower may be used, if present.

As used herein, a cellular tower's ID and signal strength is used to detect the changes/movement of user's location relative to a previous one, (and not for example, the absolute location of the mobile telephone 102). Such differences may be obtained by changes in a cellular tower's signal strength. In addition, the accuracy of such location distance can be improved by detecting more signal changes corresponding to other towers.

As used herein, the number of cellular towers that may be detected by a mobile telephone 102 is N. whereby those towers can be indexed as Tᵢ, i=1,2 . . . N.

Further, the averaged signal strength from those towers can be indexed as S̅ⁱ, i=1,2 . . . N. For each sample when the timer 108 described herein is triggered, the signal strength at that time may be represented as Sⱼⁱ, i=1,2 . . . N, where j is the slot index of the timer 108.

The signal difference at timer j for tower id i is defined as:

δⱼⁱ=Sⱼⁱ−Sⱼ₋₁ⁱ (1)

The cellular footprint is for all the cellular towers' signal strengths is defined as a vector of signal strength:

\vec{S}=(S¹, S² . . . , Sⁿ) (2)

When the mobile user moves, the footprint changes. However, if the towers are the same as before (relatively small speed of movement), the difference of the cellular footprint, averaged by the signal strength of the cellular tower, is used for the changes of the signal strength to calculate location difference at time j.

$${δ}_{j} = ( {\sum }_{i} {\overline{s}}^{i} {δ}_{j}^{i} ) / {\sum }_{i} {\overline{s}}^{i} \qquad ( 3 )$$

When the mobile user moves, and the tower ID on the footprint also changes, two cases are differentiated. First, if one of the three strongest tower IDs disappears, the mobile telephone 102 is considered to be moving very quickly. Second, if one of the tower IDs disappears (one or more new IDs may or may not appear), but the one that disappeared was not one of the three strongest, then δⱼ is calculated according to equation (3).

When δⱼ (the difference of weighted averaged signal strength, the logic calculates the distance of the location according to the radio technology used. Typically, a table is used to store a map of the signal strength and distance. Note that the distance function exemplified herein may be replaced by a difference of the signal strength if the cellular radio type is given, e.g., GSM radio.

As described herein, when the user is at different locations, different scanning strategies are adopted. Note that the user's exact location need not be known, but rather only the movement when compared with a previous location, as a granularity of ten meters is generally sufficient for scanning purposes. As also described herein, by logging the footprint history 112, the number of unnecessary scan can be greatly reduced.

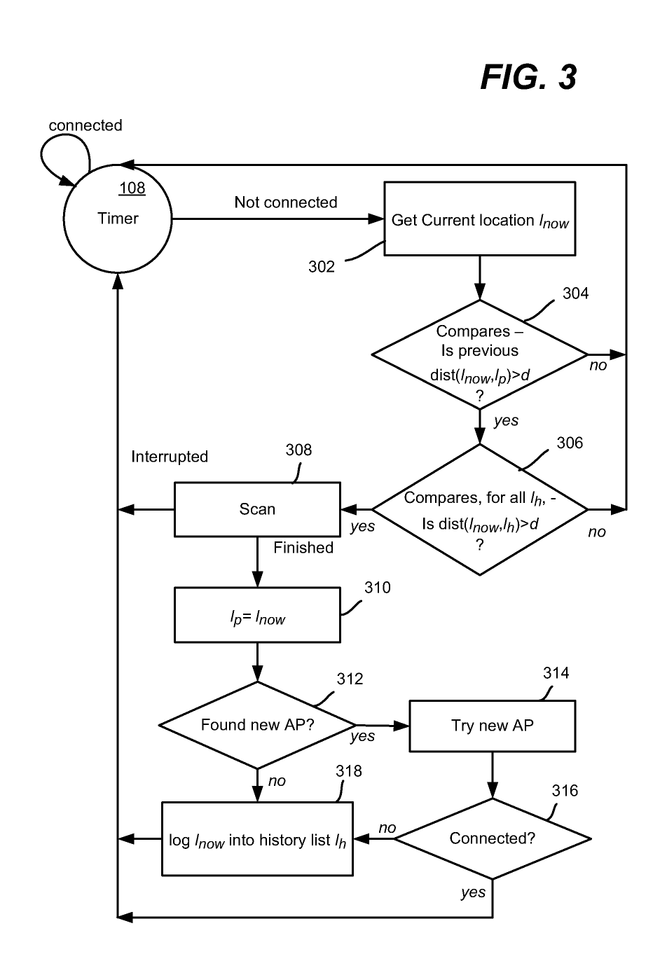

The logic of one suitable scanning scheme is represented in FIG. 3. A timer 108 (FIG. 1) is periodically triggered. If the mobile telephone 102 is connected, then the timer goes to sleep, otherwise at step 302 the logic obtains the current location of the mobile telephone 102, shown as I_{now}. Based on I_{now} versus a previous location value Iₚ, the logic makes a scanning determination.

As represented by step 304, if the mobile telephone 102 has not moved a sufficient distance relative to the previous location Iₚ (larger than a threshold d), then the logic 104 goes back to the timer 108. Note that anytime the logic returns to the timer 108, the timer may be reset. Further note that the timer trigger period may be configurable and/or variable, e.g., to check more often when battery power is high, less often when battery power is low, or based on any other suitable criteria.

Otherwise, the mobile telephone 102 has moved. In general, to improve performance and reduce unnecessary scans when user moves between several locations, the concept of history entries is used. That is, when a new location is found and a scan has been performed, the logic logs the location into the history, and differentiates two cases, namely one for access point found, and the other for no access point found. Thus, when the comparison at step 304 is performed, the logic checks whether the location is different from that in history where no AP found. This further comparison handles the case in which the user has moved between several nearby locations, in which there is no access point in any of them.

This is represented by step 306, which determines whether the distance of the current location to the history logs (where no access point was found for those locations, denoted by Iₕ) is larger than d. If not, the logic returns to the timer 108.

If yes for all history entries, scanning is performed as represented by step 308. Note that scanning takes time to complete, and if interrupted the logic returns to the timer. If scanning completes, the current location is saved as the previous location at step 310.

Step 312 evaluates whether there is a new access point that can be tried. If so, an attempt to connect is made at step 314, and if connection is successful (step 316), the logic returns to the timer. If no new access point can be tried, or the connection attempt fails, the current location is logged into the history data at step 318 before returning to the timer 108.

It should be noted that a scan may never be performed via the logic of FIG. 3, e.g., if the user does not move or the history indicates a low likelihood of success based on a past footprint indicating failure to connect that matches the current footprint. However, it is possible that a new access point will be detectable such as one that is newly activated or if conditions change. Thus, a manual or timed override (e.g., via a second timer) can force a scan if one is not performed for too long of a time period. Thus, although not explicitly shown, the scan logic may include or be overridden by a mechanism that forces a scan, e.g., by jumping directly to step 308.

To choose a distance threshold parameter d, consider that the purpose of scanning is to find potential access points for connecting. When the mobile telephone 102 user does not move a sufficient distance, then the probability of finding a new access point is relatively small. As people are subject to move around in short distances compared with an access point's coverage range (tens of meters for indoor and up to hundred meters for outdoor), both the moving distance and a typical access point's coverage distance are considered. Note that the coverage range for mobile telephone 102 is further constrained because it is less powerful.

Thus, the parameter d may be tunable for different scenarios. In one implementation, a distance of d equal to ten meters was chosen for indoor and twenty meters for outdoor. The threshold may be automatically or manually changed, such as based on other criteria, e.g., when the user is detected as being at home or in the office (e.g., by a Bluetooth® connection between the mobile telephone 102 and a computing device).

### Exemplary Operating Environment

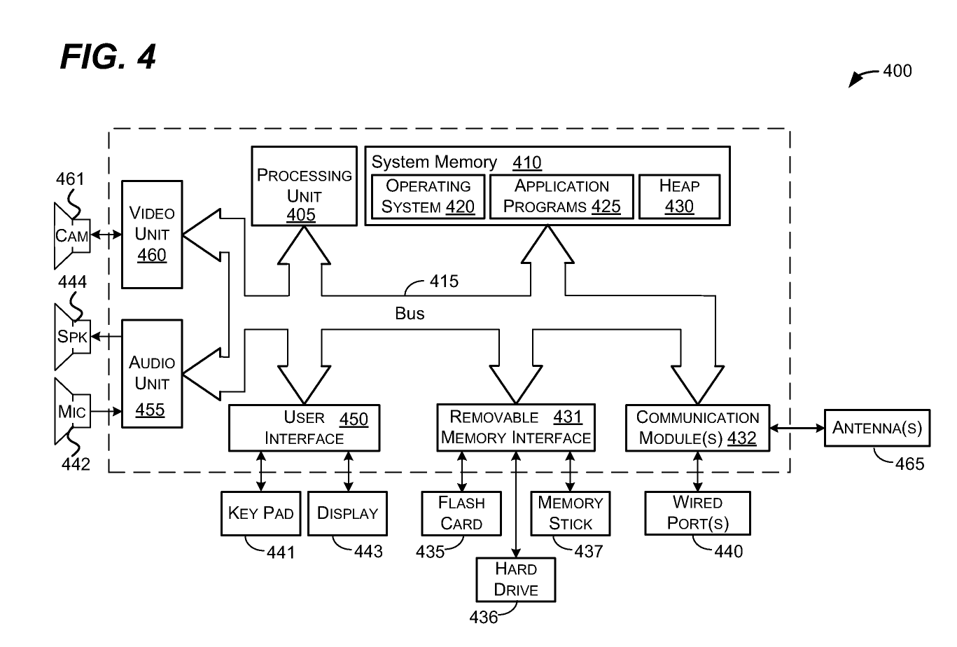

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 comprises a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-137 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a media playback device, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a mobile computing environment, a method comprising, determining whether a mobile device that is not connected to a Wi-Fi access point has moved beyond a threshold distance, and if not, delaying Wi-Fi scanning for an access point, and if so, using further information to determine whether to perform a Wi-Fi scan for an access point.

2. The method of claim 1 wherein determining whether the mobile device has moved comprises processing cellular tower information received at the mobile device.

3. The method of claim 2 processing the cellular tower information comprises evaluating cellular tower identifiers, or signal strength information from corresponding cellular towers, or both cellular tower identifiers and signal strength information from corresponding cellular towers.

4. The method of claim 3 wherein evaluating the cellular tower identifiers comprises determining whether a cellular identifier corresponding to one of the most powerful signal strengths was previously detected and is no longer detected.

5. The method of claim 3 wherein using further information to determine whether to perform a Wi-Fi scan for an access point comprises accessing historical information to determine whether a current location of the mobile device is known to be a location in which connection to an access point is likely to fail, and if likely to fail, delaying the scan.

6. The method of claim 5 further comprising, scanning for an access point, and if no access point is found, or if an access point is found but the mobile device cannot connect thereto, logging information regarding the current location in the historical information.

7. The method of claim 1 wherein using further information to determine whether to perform a Wi-Fi scan for an access point comprises determining if the mobile device is moving too quickly relative to a threshold, and if so, delaying the Wi-Fi scanning for an access point.

8. In a mobile communications environment, a system in a mobile device, comprising, scan logic that determines whether to scan for a Wi-Fi access point based on current footprint data, the current footprint data comprising cellular tower identifiers and corresponding signal strengths, the scan logic coupled to a memory to determine whether the mobile device has moved by accessing previous footprint data in the memory and comparing the previous footprint data to the current footprint data, and if the mobile device has not moved beyond a threshold difference, delaying the scan.

9. The system of claim 8 wherein the scan logic is coupled to a timer that triggers the scan logic's determination as to whether to scan for a Wi-Fi access point.

10. The system of claim 8 wherein the scan logic determines that the mobile device has moved beyond the threshold difference, wherein the scan logic accesses historical data in the memory to determine whether the current footprint corresponds to a location in which the historical data indicates that the likelihood of connecting to an access point is low, and if the historical data indicates that the likelihood of connecting to an access point is low, the scan logic delaying the scan.

11. The system of claim 8 wherein the mobile device obtains the footprint via GSM, CDMA, or 3G technology.

12. The system of claim 8 wherein the threshold difference is configurable.

13. The system of claim 8 further comprising a mechanism that forces a scan.

14. One or more computer-readable media having computer-executable instructions, which when executed perform steps, comprising:
(a) waiting for a trigger;
(b) when the trigger is reached, determining whether a mobile device is connected to a Wi-Fi access point, and if so, returning to step (a);
(c) determining whether the mobile device has moved beyond a threshold difference since a previous Wi-Fi scan for an access point, and if not, returning to step (a);
(d) obtaining further information based upon device movement to determine whether to perform a Wi-Fi scan for an access point, and if not, returning to step (a); and
(e) performing a Wi-Fi scan for an access point.

15. The one or more computer-readable media of claim 14 wherein obtaining further information based upon device movement comprises determining whether the mobile device is moving too quickly.

16. The one or more computer-readable media of claim 14 wherein determining whether the mobile device has moved beyond a threshold difference comprises evaluating a previous location based upon previous footprint data against a current location based upon current footprint data, in which the previous and current footprint data is determined from cellular tower identifiers, or signal strength information from corresponding cellular towers, or both cellular tower identifiers and signal strength information from corresponding cellular towers.

17. The one or more computer-readable media of claim 16 wherein evaluating the previous location based upon previous footprint data against the current location based upon current footprint data comprises determining whether a cellular identifier corresponding to one of the most powerful signal strengths was previously detected and is no longer detected.

18. The one or more computer-readable media of claim 14 wherein obtaining further information based upon device movement comprises accessing historical information to determine whether a current location of the mobile device is known to be a location in which connection to an access point is likely to fail, and if likely to fail, delaying the scan.

19 The one or more computer-readable media of claim 18 having further computer-executable instructions comprising, logging information about the current location in the historical information, when, after scanning for an access point at step (e), no access point is found, or an access point is found but the mobile device cannot connect thereto, and returning to step (a).

20. The one or more computer-readable media of claim 18 having further computer-executable instructions comprising, connecting to a new access point after step (e), and returning to step (a).
